(19) United States
(12) Patent Application Publication
(10) Pub. No.: US 2008/0112692 A1
(43) Pub. Date: May 15, 2008

(54) Method and apparatus for converting digital pictures for storage and playback from optical discs

(75) Inventors: Vincent Chiu, Union City, CA (US); Joseph Maciel, San Jose, CA (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony Electronics, Inc., Park Ridge, NJ (US)

(21) Appl. No.: 11/783,955

(22) Filed: Apr. 13, 2007

Related U.S. Application Data
(60) Provisional application No. 60/858,183, filed on Nov. 9, 2006.

(51) Int. Cl. H04N 5/85

(52) U.S. Cl. 386/126; 386/E05.064

(57) ABSTRACT

Digital image conversion for storage on an optical disc and corresponding playback on an optical disc player is disclosed. Digital image conversion may convert images from external devices in an environment where the internal memory is insufficient to support retention of an entire optical disc image to be written onto the optical disc. The conversion entails iteratively accessing digital image files to be converted, encoding and storing them on the optical disc in the appropriate format, and building a navigational structure that is used to accommodate playback of the images from the optical disc. In one example, the digital image format of the source image files is JPEG, and the optical disc and playback format is a DVD format, with the encoded image file forming a packetized elementary stream, and the video file format being a DVD compliant program stream.

### CROSS REFERENCE TO RELATED APPLICATIONS

This application is claims the benefit under 35 U.S.C. § 119 to provisional application Ser. No. 60/858,183, filed on Nov. 9, 2006, the entire contents of which are hereby incorporated by reference.

### BACKGROUND OF THE INVENTION

1. Field of the Invention

This invention relates generally to converting digital images and more particularly converting and storing digital image files on an optical disk for slideshow playback.

2. Description of the Related Art

With the popularity of digital cameras in the market, sharing digital pictures among family and friends has become very common. This may often be done by transferring and storing images on a computer, and then e-mailing or uploading the images for viewing and other enjoyment by designated recipients.

While these modes of enjoyment are convenient and useful in some circumstances, this is not always the case, particularly for those who do not have a personal computer. Many households do, however, have televisions and DVD players. It would be convenient to allow users to easily transfer image files from devices such as digital cameras, camcorders, and flash memory products to optical discs such as DVDs, so that the images can be conveniently enjoyed via their home optical disk player and connected television.

In a personal computer environment, software applications can utilize a sizable hard disk drive and relatively robust processing resources to create an entire DVD disk image on the hard disk drive, and then write out the entire disk image onto a writable DVD. The DVD may then be read by a DVD player for playback in conventional fashion.

Other devices have been developed for scanning photographs, slides and the like, and then storing the corresponding digital information on media for playback. However, while these devices may be useful for scanning old photographs to make them more useable in digital environments, they do not accommodate convenient transfer from existing digital devices such as digital cameras. Additionally, there is no accommodation for memory constraints in situations where several digital images require writing to optical discs.

There is a need for techniques useful for accommodating a transfer of image, files onto an optical disc such as a DVD disc in environments where processing resources and memory is limited, such that the DVD disc image could not be stored in the available amount of memory.

### SUMMARY OF THE INVENTION

The present invention provides digital image conversion for storage on an optical disc and corresponding playback on an optical disc player.

In one embodiment, digital image conversion converts images from external devices and does so in an environment where the internal memory is insufficient to support retention of an entire optical disc image to be written onto the optical disc. The conversion entails accessing digital image files to be converted, encoding and storing them on the optical disc in the appropriate format, and building a navigational structure that is used to accommodate playback of the images from the optical disc.

Conversion comprises accessing a digital image file stored on the external device in a digital image format, and decoding the image file to provide a decoded image file as raw digital image data. The decoded image file is then encoded to provide an encoded image file having a video file format, and the encoded image file is stored on an optical disc in a location designated for video files. This process is iteratively repeated for each of one or more remaining image files to compile a series of images files on the optical disc.

While the iterative process takes place, information corresponding to each encoded image file that is stored on the optical disc is retained and built into a navigation structure for the series of image files. When the image file conversion and storage on the optical disc in the video file area is completed, the navigation structure is stored on the optical disc in a location designated for navigational information.

Although a variety of alternatives may be provided, in one embodiment, the digital image format of the source image files is JPEG, and the optical disc and playback format is a DVD format. For example, the encoded image file may form a packetized elementary stream, with the video file format being a DVD compliant program stream.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a diagram illustrating an embodiment of an optical disc recording device and corresponding devices.

FIG. 2 is a block diagram illustrating an embodiment of an optical disc recording device in further detail.

FIG. 3 is a block diagram illustrating an embodiment of a digital image conversion module of the optical disc recording device.

FIG. 4 is a flow diagram illustrating an embodiment of a process for converting digital images.

FIGS. 5A and 5B are diagrams illustrating optical disc layouts with areas for storing converted digital images.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

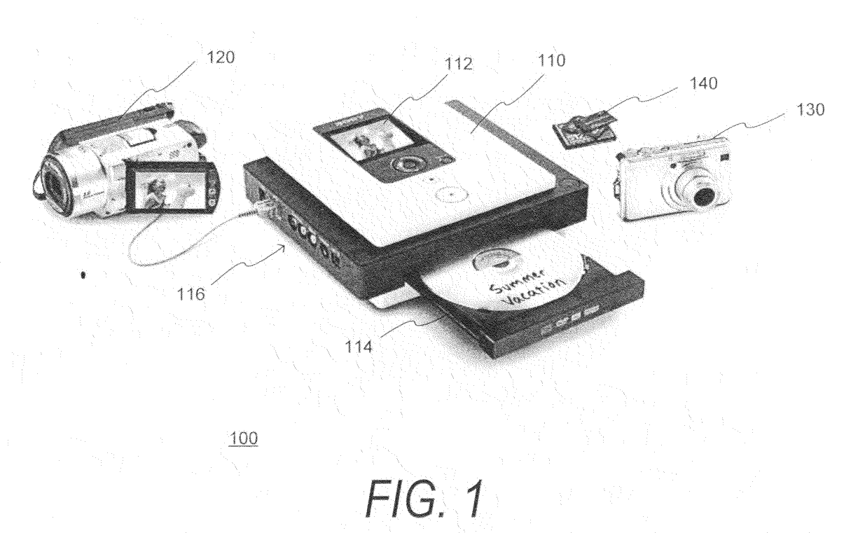

FIG. 1 is a diagram illustrating an embodiment of an optical disc recording device 110 and corresponding devices 120, 130, 140. The optical disc recording device 110 is equipped with one or more interfaces 116 for communicating with devices that potentially hold digital images to be converted. An optional display 112, such as an LCD screen type display, as well as corresponding interface buttons may be used to allow users to navigate among images and to select images desired for conversion.

As illustrated, a variety of devices may interface with the optical disc recording device 110, including but not necessarily limited to a camcorder 120, a digital camera 130, and a flash memory 140. Each of these devices includes some form of memory that potentially stores digital images, typically in JPEG format but potentially in a variety of standard or native formats, including but not limited to DCF2.0.

Various conventional interfaces may be used to accommodate the connection to each of these devices, including but not limited to a USB port for various connections, as well as a memory card slot compatible with one or more flash memories such as Memory Stick Duo™, Memory Stick®, SD™ Memory Card, xD Picture Card™, Compact Flash® and others.

The optical disc recording device 110 also includes a conventional interface 114 such as a sliding tray for receiving an optical disc on which converted digital images are to be recorded. A variety of recordable disc formats for photo image conversion may also be used, including DVD+R, DVD+RW, DVD−R, and DVD−RW.

Additional options include connection to a personal computer, connection to printers to allow paper copies of images to be printed, provision of video conversion and storage, and others.

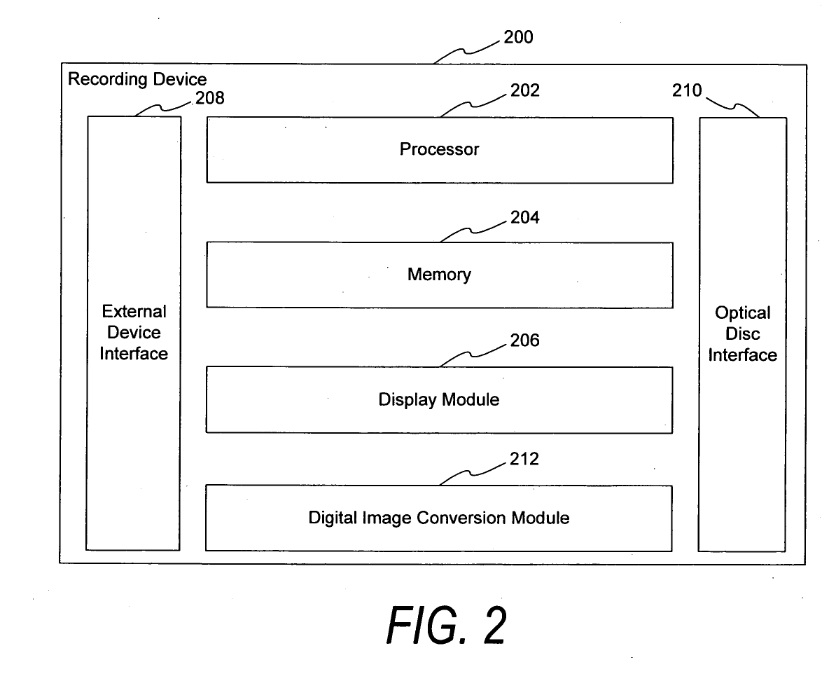

FIG. 2 is a block diagram illustrating an embodiment of an optical disc recording device 200 in further detail. The optical disc recording device 200 includes the external device interface(s) 208, optical disc interface 210 and display module 206 for respectively providing the interface to external devices, the interaction with optical discs and the optional video display capabilities as described above. Each of these interfaces may be provided using conventional interfacing and corresponding hardware. The optical disc recording device 200 also includes a processor 202 and memory 204 for carrying out the functionality described herein.

The digital image conversion module 212 includes instructions that, when executed by the processor, carry out the conversion of digital images stored on such external devices for storage and presentation from optical discs, particularly DVDs. The digital image conversion module 212 is preferably provided as software but may alternatively be provided a firmware or a combination of software and firmware.

The digital image conversion module 212 accommodates the conversion of images from external devices and does so in an environment where the memory is insufficient to support retention of an entire optical disc image on the device. This is performed by iteratively accessing digital image files to be converted, building a navigational structure and storing the converted image files and ultimately the navigational information on the optical disc.

In one embodiment, the digital image conversion module 212 accesses image files stored on an external device and having a digital image format, then decodes one of the image files to provide a decoded image file as raw digital image data. The decoded image file is encoded to provide an encoded image file having a video file format, and the encoded image file is stored on an optical disc in a location designated for video files. This process is iteratively repeated for each of one or more remaining image files to compile a series of images files on the optical disc.

While the iterative process takes place, information corresponding to each encoded image file that is stored on the optical disc is retained and built into a navigation structure for the series of image files. When the image file conversion and storage on the optical disc in the video file area is completed, the navigation structure is stored on the optical disc in a location designated for navigational information.

Although a variety of alternatives may be provided, in one embodiment, the digital image format of the source image files is JPEG, and the conversion format is a DVD format. For example, the encoded image file may form a packetized elementary stream, with the video file format being a DVD compliant program stream.

Additionally, DVD VOB files and DVD compliant program streams can be used interchangeably. For reference purpose, DVD VOB is valid program stream containing additional information for enabling smooth video playback and trick plays, such as fast forward, fast rewind, search, and pause.

Additionally, although any architecture to accommodate the described functionality may be provided, in one embodiment the processing architecture comprises two chipset processors, Cirrus Logic CS98200 and CS92288. The CS92288 processor is primarily used for MPEG video encoding, and the CS98200 is used as the host processor and the video decoder. With regard to creating slideshows and the like, the CS98200 processor may be used primarily for control and JPEG decoding, with the decoded raw image data being encoded by the CS92288 processor as an MPEG2 video I-frame. Once the JPEG image picture has been decoded into raw data in the memory buffers, the CS92288 processor is used to convert the raw image data into the MPEG 2 I-Frame format. Thereafter, the slideshow module runs on a RISC processor in the CS98200 processor to create DVD compliant streams. The CS98200 has two general RISC type processors and one DSP for computationally intensive processing. Preferably, the JPEG decoding software module utilizes the RISC processor.

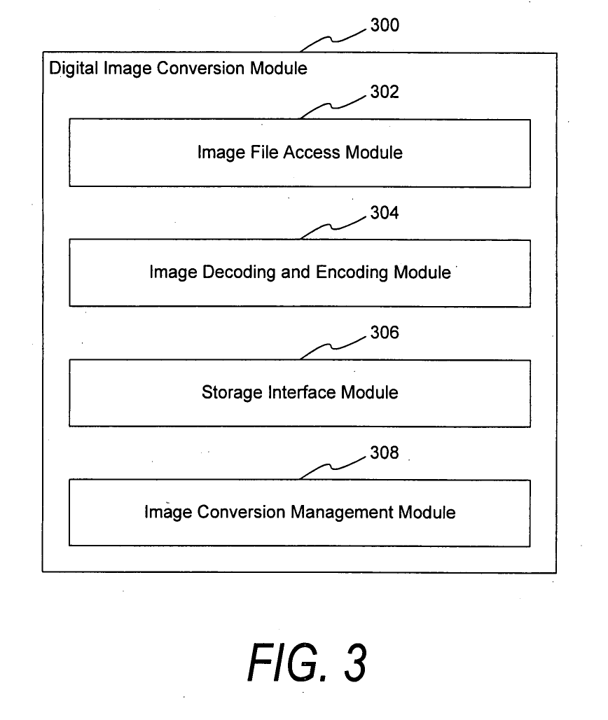

FIG. 3 is a block diagram illustrating an embodiment of a digital image conversion module 300 of the optical disc recording device in more detail. Although one modular breakdown of the functionality is illustrated and described, it should be understood that the functionality may be provided by greater, fewer, or differently named modules, without departing from the scope of the present invention.

The digital image conversion module 300 includes an image file access module 302, an image decoding and encoding module 304, a storage interface module 306, and an image conversion management module 308.

The image file access module 302 includes facilities for accessing the images stored on external devices. As such it is configured to navigate to and read files contained in the memory of external devices, including separate flash memory or that contained within the external device. The image file access module 302 is also configured to receive user input useful for determining which image files are to be converted. This may be variously carried out, such as by receiving an indication that all image files are to be converted, or an indication that particular image files in a designated location on the external device are to be converted (e.g., those in a particular folder), or an individually selected listing of image files are to be converted. In the latter example, the user may browse images stored on the external device using the display, and then designate those images that will be converted such as by pressing a “select” or other button. A listing of the images to be converted and stored on the optical disc is concurrently retained by the image conversion management module 308 as the user makes such selections.

The image conversion management module 308 also maintains the listing (or other means of identification) of images to be converted. In one embodiment, this entails storing a unique identification of each file to be converted so that they can be easily retrieved, and so that the overall number of image files to be converted may be retained and maintained to manage the conversion process. For example, the file name used by the external device may be accessed and also used to identify the files, by both the image file access module 302 and the image conversion management module 308.

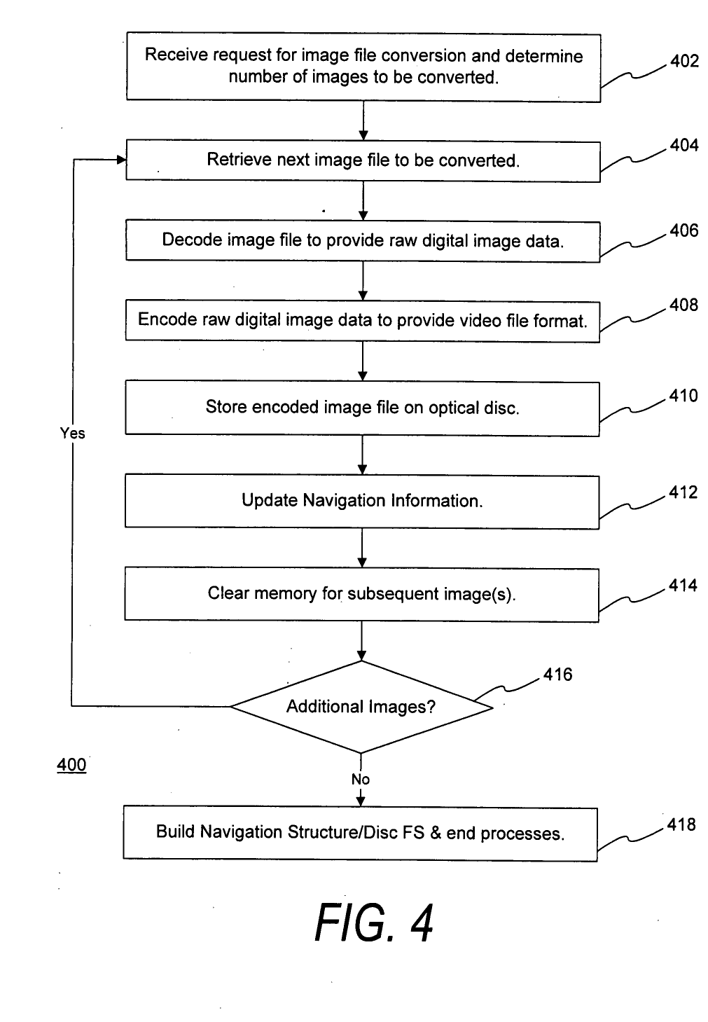

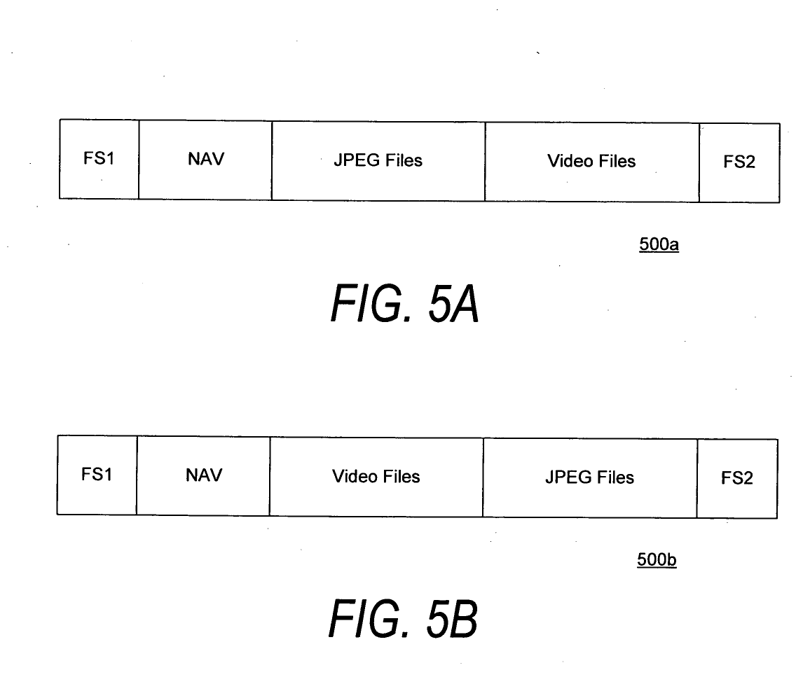

The image decoding and encoding module 304 includes instructions for decoding image files to provide raw digital image data, and encoding the raw digital image data into a particular format used by the optical disc. Conventional decoding and encoding formats may be used for these functions, as dictated by the formats used by the source and destination media. The process of decoding and encoding is also described further with reference to FIGS. 4, 5A-B below.

The storage interface module 306 communicates with the optical disc writing facilities of the optical disc recording device and thus facilitates storing the encoded image files on the optical disc, preferably in a location designated for video files as will be described further below. The storage interface module also facilitates storing navigational information on the optical disc.

The image conversion management module 308 maintains the listing of images to be converted, and thus also manages the number of images to be converted as well as the usage of the limited memory of the optical disc recording device in carrying out the process of converting images and storing them on the optical disc. The image conversion management module 308 thus manages a process whereby the images are iteratively accessed, retrieved, decoded, encoded and stored on the optical disc, in the appropriate area of the optical disc. In addition, the image conversion management module 308 ensures that the limitations imposed by memory capacity are not exceeded. In one embodiment, this entails using a working area of the memory to retrieve the image to be converted, store the raw digital image data, and then store the encoded image for writing to the optical disc. This information is then deleted (such as by allowing it to be overwritten) so that the next image or set of images may be processed.

Finally, the image conversion management module 308 establishes and maintains navigational information as image files are converted, and builds the corresponding navigational structure to be written to disc upon completion of the conversion processes, which allows slideshow and other playback functionalities through the DVD or other optical disc player at a later time.

FIG. 4 is a flow diagram illustrating an embodiment of a process 400 for converting digital images, and FIGS. 5A and 5B are diagrams illustrating optical disc layouts with areas for storing converted digital images. The functionality of the optical disc recording device in carrying out image file conversion is further described with reference to these figures.

To accommodate the storage of converted image files for playback in a slideshow of the like, four categories of data are written to the optical disc, including the file system, DVD navigation information, DVD compliant streams, and JPEG files for the picture. FIGS. 5A and 5B illustrate optical disc layouts 500a, 500b that may respectively be used to accommodate slideshow and other playback based upon converted images stored on DVD−R/−RW/+R media and DVD+RW media. Each of these layouts 500a, 500b includes two file system areas FS1 and FS2, a navigational area (NAV), as well as areas for JPEG files and Video files, with the last two areas being reversed in the respective layouts.

The process 400 includes receipt 402 of a request for image file conversion as well as some corresponding determination of the number of files to be converted. This is described further above, wherein the user may variously designate or individually select images for conversion, and wherein the identity of image files to be converted is maintained such as by unique file name, number or the like. This allows an iterative progression through the image conversion process. The first (next) image file to be converted is retrieved 404, then decoded 406 to provide raw digital image data, and then the raw digital image data is encoded 408 to provide the video file format.

In one embodiment, the source image files are presented in JPEG format and the playback device and optical disc are DVD. JPEG is a compression format used to reduce the size of the photo file while preserving its quality. However, JPEG is not used in DVD video, which uses the MPEG compression format because of its coding efficiency for video data. Accordingly, the JPEG image file is converted to an MPEG stream format for writing to the DVD disc in support of slideshow or other playback using a DVD player.

To accommodate the conversion, the image file is uncompressed to raw image data and then encoded (compressed) into an MPEG 2 I-frame. The I-Frame data of different pictures forms a video-like stream, called a Packetized Elementary Stream (PES), from which a DVD video compliant Program Stream (PS) is constructed. For each converted image file (e.g., photo), the newly constructed PS is written (410) to the video files area according to the optical disc layout (e.g., FIGS. 5A-B). Note that navigation information may be located in two areas, one within the Program Stream and the other in the designated navigation structure only area. The information embedded in PS is written to the disc during the iterative process of decoding, encoding, stream constructing, and storing in the video file area. The other part of navigation structure in created at the end and store in the navigation file area.

A navigation structure is also established as part of the conversion process. This navigation structure ultimately will be written to the optical disc, but during the iterative conversion the corresponding navigation information may be maintained in memory. Accordingly, once a converted image file is written to the video files area, the navigation information may be updated 412 accordingly. For example, the navigation information comprises entry pointers to title, chapter of DVD slideshow, as well as forward and backward timing references. Such navigation enables features like title jump, chapter jump, and fast forward, fast rewind, pause and search play.

Following this, the relevant area of the memory may be cleared 414 to accommodate processing of the next image. The iterative retrieval, decoding, encoding and storing of image files is then furthered until it is determined 416 that no additional images are to be converted. The iterative nature of the sequence is significant as it accommodates the creation of slideshows and the like in situations where the corresponding device has only limited memory available. In the PC environment, a 2-pass technique could be used, wherein at first, all of the JPEG images are converted into MPEG 2 video stream and stored on the Hard Disk Drive. There, a second step generates the navigation information structure from the entire MPEG 2 encoded Program Stream. By contrast, according to this embodiment, the navigation information is preferably generated as soon the Program Stream is constructed.

At this point, disc end processes and the finalization and writing of the navigation structure is completed (418). In the above example, once all of the JPEG photo files have been converted to PS, the DVD navigation structure can be created from the navigation information gathered during the JPEG conversion process. The navigation structure may then be written to the NAV area of the optical disc.

A file system, preferably one including ISO 9660 and UDF for compatibility, is created and written to reflect the contents of the disc. This may entail first writing the file system to the first file system area FS1 and then using the second file system area FS2 where the first is insufficient to accommodate the size of the file system.

The formatting constraints of a given conversion process will be dictated by the source and conversion formats, as well as the corresponding specifications that are well know and readily available for any number of potential formats.

Thus embodiments of the present invention produce and provide digital image conversion and corresponding storage on optical discs. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method for converting digital images and storing them for playback on an optical disc player, the method comprising:
accessing image files stored on an external device and having a digital image format;
decoding one of the image files to provide a decoded image file as raw digital image data;
encoding the decoded image file to provide an encoded image file having a video file format;
storing the encoded image file on an optical disc in a location designated for video files;
iteratively repeating the decoding, encoding, and storing steps for each of one or more remaining image files to compile a series of images files on the optical disc.

2. The method of claim 1, further comprising:
retaining information corresponding to each encoded image file that is stored on the optical disc;
building a navigation structure for the series of image files from the retained information; and
storing the navigation structure on the optical disc in a location designated for navigational information.

3. The method of claim 1, wherein the optical disc player is a DVD player.

4. The method of claim 1, wherein the digital image format is JPEG.

5. The method of claim 1, wherein the video file format is a DVD format.

6. The method of claim 1, wherein the encoded image file forms a packetized elementary stream, and the video file format is a DVD compliant program stream.

7. A system for converting digital images and storing them for playback on an optical disc player, the system comprising:
means for accessing image files stored on an external device and having a digital image format;
means for decoding one of the image files to provide a decoded image file as raw digital image data;
means for encoding the decoded image file to provide an encoded image file having a video file format;
means for storing the encoded image file on an optical disc in a location designated for video files; and
means for iteratively repeating the decoding, encoding, and storing steps for each of one or more remaining image files to compile a series of images files on the optical disc.

8. The system of claim 7, further comprising:
means for retaining information corresponding to each encoded image file that is stored on the optical disc;
means for building a navigation structure for the series of image files from the retained information; and
means for storing the navigation structure on the optical disc in a location designated for navigational information.

9. The system of claim 7, wherein the optical disc player is a DVD player.

10. The system of claim 7, wherein the digital image format is JPEG.

11. The system of claim 7, wherein the video file format is a DVD format.

12. The system of claim 7, wherein the encoded image file forms a packetized elementary stream, and the video file format is a DVD compliant program stream.

13. An optical disc recording device for converting digital images and storing them for playback on an optical disc player, the optical disc recording device comprising:
an image file access module, which accesses image files stored on an external device and having a digital image format;
an image decoding module, which decodes one of the image files to provide a decoded image file as raw digital image data and;
an image encoding module, which encodes the decoded image file to provide an encoded image file having a video file format;
a storage interface module, which stores the encoded image file on an optical disc in a location designated for video files; and
an image conversion management module, which iteratively repeats the decoding, encoding, and storing steps for each of one or more remaining image files to compile a series of images files on the optical disc.

14. The optical disc recording device of claim 13, wherein the image conversion management module also retains information corresponding to each encoded image file that is stored on the optical disc and builds a navigation structure for the series of image files from the retained information, wherein the navigation structure is stored on the optical disc in a location designated for navigational information.

15. The optical disc recording device of claim 13, wherein the optical disc player is a DVD player.

16. The optical disc recording device of claim 13, wherein the digital image format is JPEG.

17. The optical disc recording device of claim 13, wherein the video file format is a DVD format.

18. The optical disc recording device of claim 13, wherein the encoded image file forms a packetized elementary stream, and the video file format is a DVD compliant program stream.
